(19) United States
(12) Patent Application Publication
(10) Pub. No.: US 2009/0224552 A1
(43) Pub. Date: Sep. 10, 2009

(54) Multiple Turbine Energy Collector and System

(76) Inventor: Joseph N. Sulentic, Oxford, IA (US)

Correspondence Address: PATWRITE LLC, 408 W. MAIN ST., MARSHALLTOWN, IA, 50158-5759, US

(21) Appl. No.: 12/144,515

(22) Filed: Jun. 23, 2008

Related U.S. Application Data
(60) Provisional application No. 60/945,638, filed on Jun. 22, 2007.

(51) Int. Cl. F03D 9/00

(52) U.S. Cl. 290/55

(57) ABSTRACT

A multiple turbine energy collector and system comprises a plurality of turbines connected using a transmission system to transfer the movement of the turbines to rotate a generator to generate an electric current. In one embodiment, the turbines are arranged linearly with a gearing transmission means to couple the plurality of turbines to the generator. Other embodiments comprise a belt driven transmission or a chain driven system to drive the generator. In yet another embodiment, the turbines are stacked vertically. An independently rotating wind facing aerodynamic shroud covers a portion of the turbines creating a venturi shaped opening which increases airflow around the turbines and creates a low pressure region on the drag side of the turbines. The turbines are Vertical-Axis Wind Turbines (VAWTs) and may be either a drag or lift type.

This application claims priority and herein incorporates by reference U.S. provisional patent application Ser. No. 60/945,638, filed Jun. 22, 2007.

### BACKGROUND OF THE INVENTION

Energy use has transformed human life and allowed us to populate many different climates and environments. As developing countries move to join the 21^{st} century, more and more energy is needed. For many years now, fuels such as oil and coal have provided the developed world with cheap and easy to use energy sources. However; although vast, the supply of these energy sources are limited and finite which has led to much higher energy costs.

These developments have led to renewed and increased interest in alternative sources of energy. The most important of these include sun, wind, tides and geothermal sources. In 2005, the total world production of these alternative sources amounted to about 14% of the world's total energy consumption. Wind power accounts for a just under 5% of this total. As concerns for supply exhaustion and carbon dioxide production increase, these numbers will invariably grow.

Wind power is one of the fastest growing areas of alternative energy sources. Wind can be used to do work directly like pumping water, but the most common means of wind harvesting is using the wind to produce electricity. Wind power production is renewable and essentially produces no greenhouse gasses.

While wind power has many advantages, the generator units are expensive and require regular maintenance. In order to increase power output, users generally need to use more turbines, each one connected to a generator unit. There is a need for a way to increase power output without the expense of adding more generators.

### SUMMARY OF THE INVENTION

A multiple turbine energy collector and system comprises a plurality of turbines connected using a transmission system to transfer the movement of the turbines to rotate a generator to generate an electric current. In one embodiment, the turbines are arranged linearly with a gearing transmission means to couple the plurality of turbines to the generator. Other embodiments comprise a belt driven transmission or a chain driven system to drive the generator. In yet another embodiment, the turbines are stacked vertically. An independently rotating wind facing aerodynamic shroud covers a portion of the turbines creating a venturi shaped opening which increases airflow around the turbines and creates a low pressure region on the drag side of the turbines. The turbines are Vertical-Axis Wind Turbines (VAWTs) and may be either a drag or lift type.

Other features and advantages of the instant invention will become apparent from the following description of the invention which refers to the accompanying drawings.

### BRIEF DESCRIPTION OF THE DRAWINGS

FIG. 1 is an illustration of a multiple turbine energy collector according to an embodiment of the present invention.

FIG. 2 is a detailed view of a portion shown in FIG. 1.

FIG. 3 is another detailed view of a portion shown in FIG. 1.

FIG. 4 is an illustration of a multiple turbine energy collector according to another embodiment of the present invention.

FIG. 5 is a detailed view of a portion shown in FIG. 4.

FIG. 6 is another detailed view of a portion shown in FIG. 4.

FIG. 7 is a perspective view of an aerodynamic shroud according to the present invention.

FIG. 8 is a top perspective view of an aerodynamic shroud according to the present invention.

FIG. 9 is a top perspective view of an aerodynamic shroud according to the present invention.

FIG. 10 is a side perspective view of an aerodynamic shroud according to the present invention.

FIG. 11 is an illustration of a multiple turbine energy collector according to an embodiment of the present invention

FIG. 12 is an illustration of a multiple in-line turbine energy collector according to an embodiment of the present invention.

FIG. 13 is a perspective view of a portion of a turbine and aerodynamic shroud according to an embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

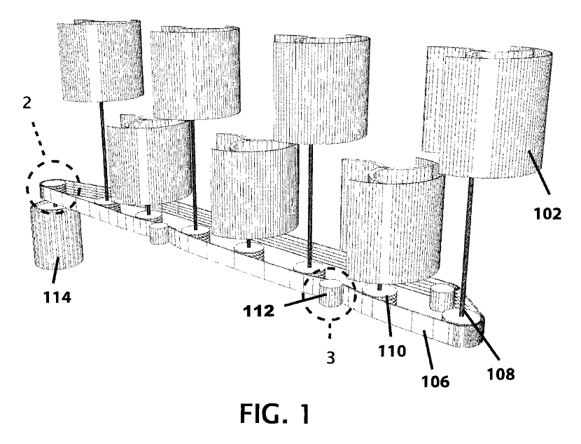

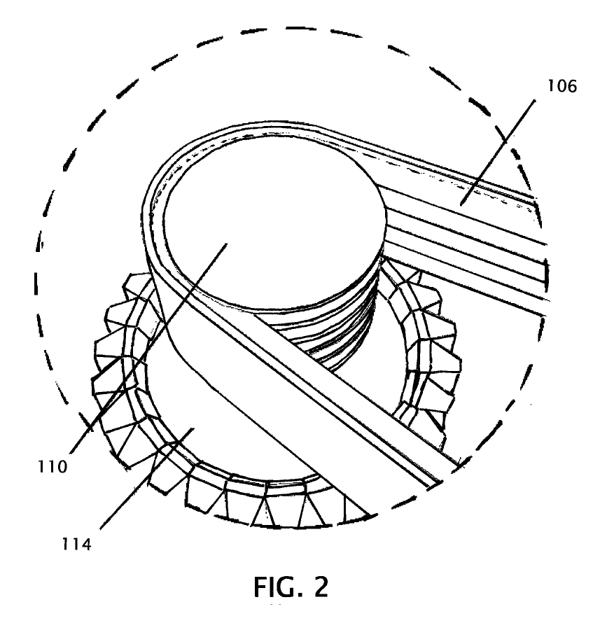

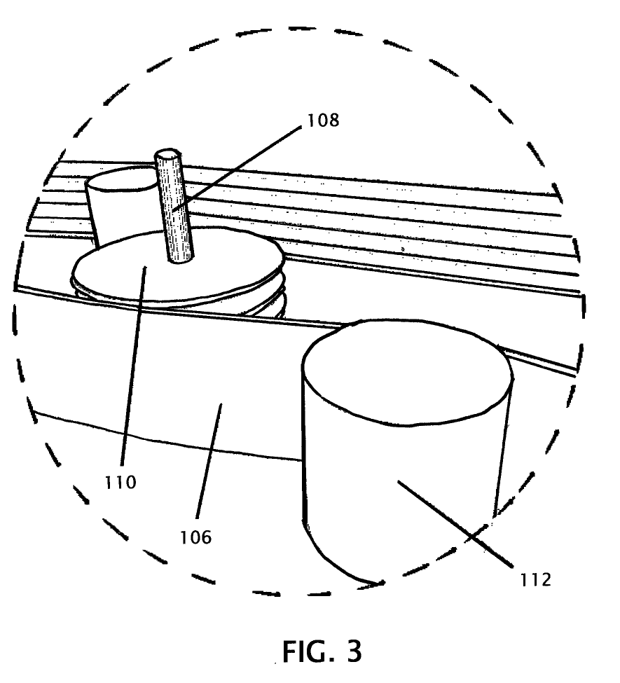

Referring to FIGS. 1-3, a multiple turbine energy collecting device 100 comprises a plurality of turbines with shrouds 102 mounted vertically on a plurality of vertical shafts 108. In the embodiment shown, turbines 102 are shown as Vertical-Axis Wind Turbines (VAWTs). Other embodiments use any suitable VAWT turbines including both lift and drag types as is known in the art such as Savonius, Darrieus, Giromill, Cycloturbine and Turby turbines. Plurality of turbines 102 are coupled together using a belt drive 106 tensioned by tensioners 112. Each turbine 102 is coupled with belt drive 106 which is connected to shafts 108. Any suitable method of engaging turbines 102 with belt drive 106 may be used. Belt drive 106 causes generator 114 to turn to produce electricity. Generator 114 is a high efficiency generator which includes the associated electrical circuitry necessary to operate generator 114 as is known in the art. Of course any generator or other rotably operated device may be connected to multiple turbine energy collecting device 100 such as pumps, mills, etc.

Generator 114 is connected to belt drive 106 by power pulley 110 which may be a direct drive or further geared as is known in the art. Additionally, a computer (not shown) may monitor and control the delivery of rotational torque to generator 114 as is known in the art. Power transfer is controlled by adjusting the tension of tensioners 112 as is known in the art. The computer (not shown) may also be used to control tensioners 112. Tensioners 112 may also be used to take generator 114 offline.

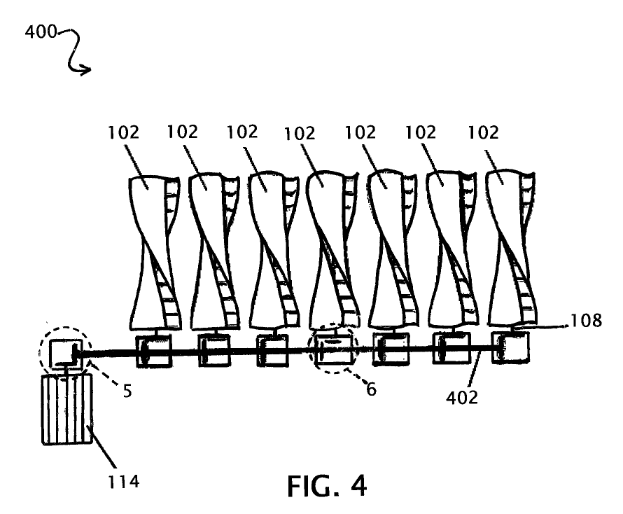

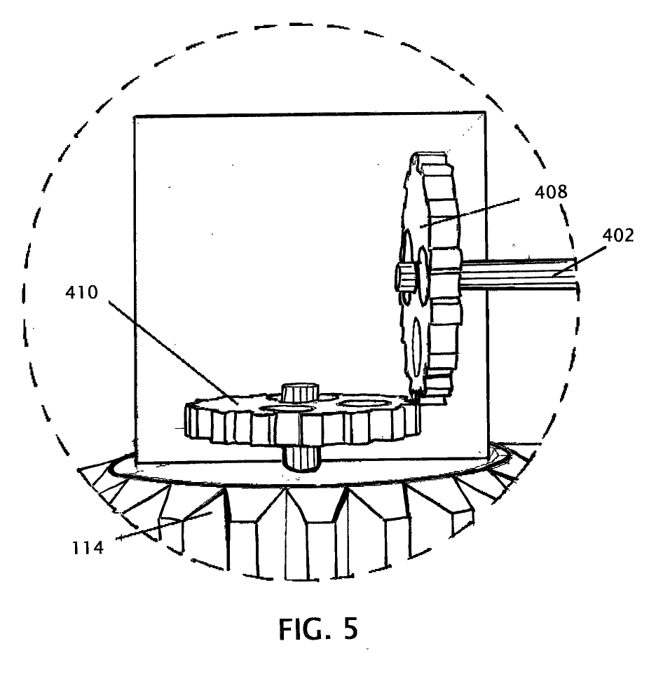

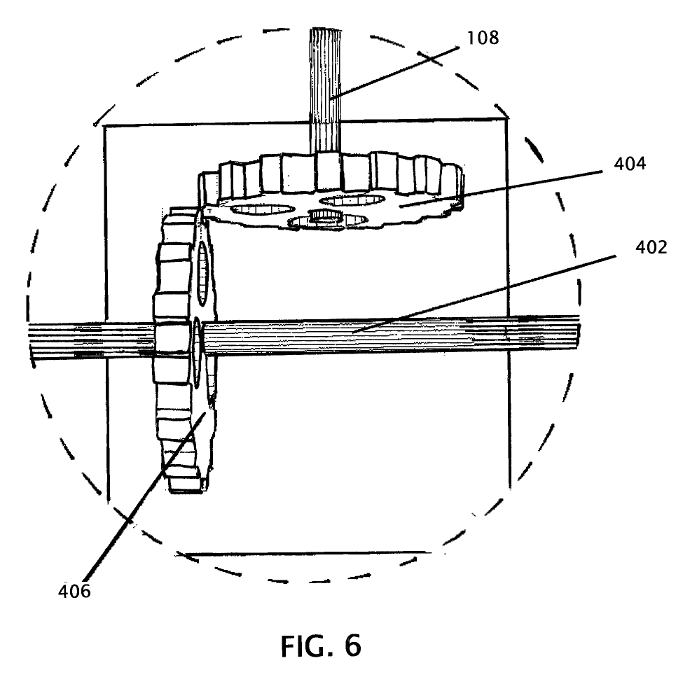

Referring now to FIGS. 4-6, a multiple turbine energy collecting device 400 comprises a plurality of turbines 102 mounted vertically on shafts 108. Vertical shaft 108 is connected to a bevel gear 404 which engages a bevel gear 406 mounted on a drive shaft 402. Generator 114 turns when drive shaft 402 rotates bevel gear 408 which engages with bevel gear 410. Of course other power coupling systems may be used such as computer controlled transmissions as is known in the art.

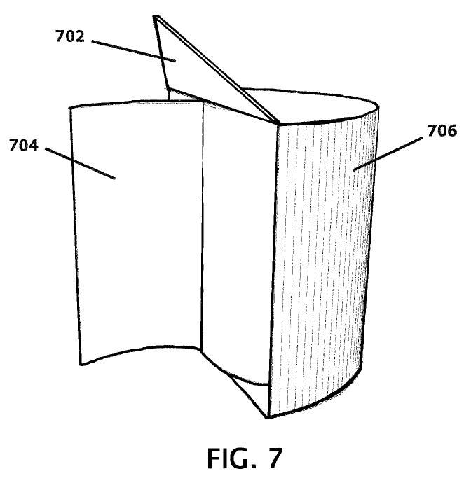

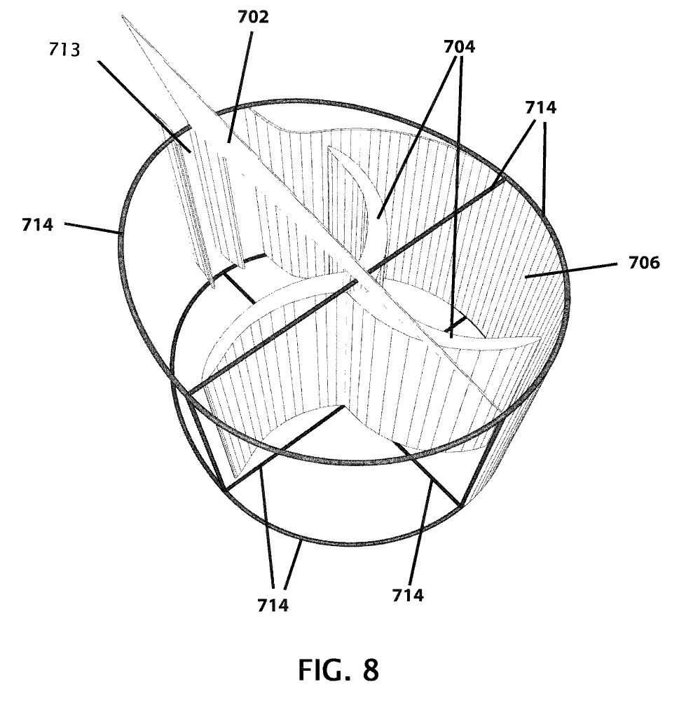

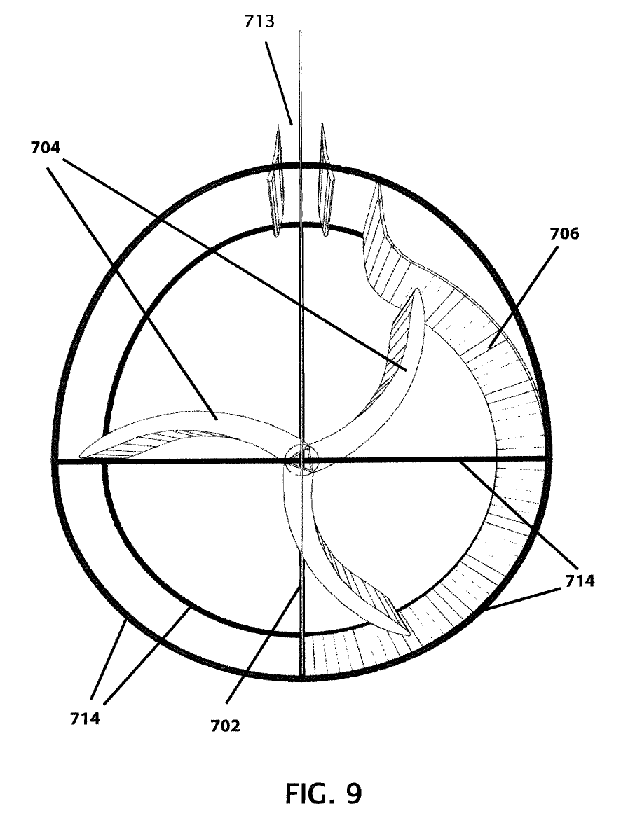

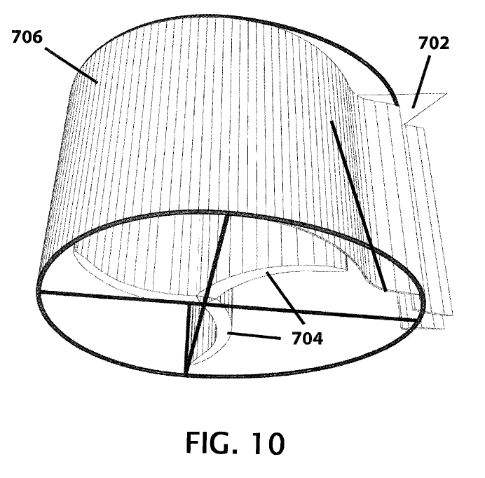

Referring now to FIGS. 7-10, an aerodynamic shroud 706 partially encloses turbines 704 which in this case are drag type turbines such as a Savonius wind turbine. Shroud 706 is held in position by structural support arms 714 which are attached to a wind directional vane 702 which aligns shroud to operate at maximum efficiently as it responds to wind direction. As the air flows through shroud 706, it is channeled around turbines 704 increasing the speed of the airflow. The shape of shroud 706 acts as venturi 713 which increases the efficiency of turbine 704 by producing a laminar flow of air across the blades of turbine 704. Shroud 706 keeps the drag side of turbine 704 covered.

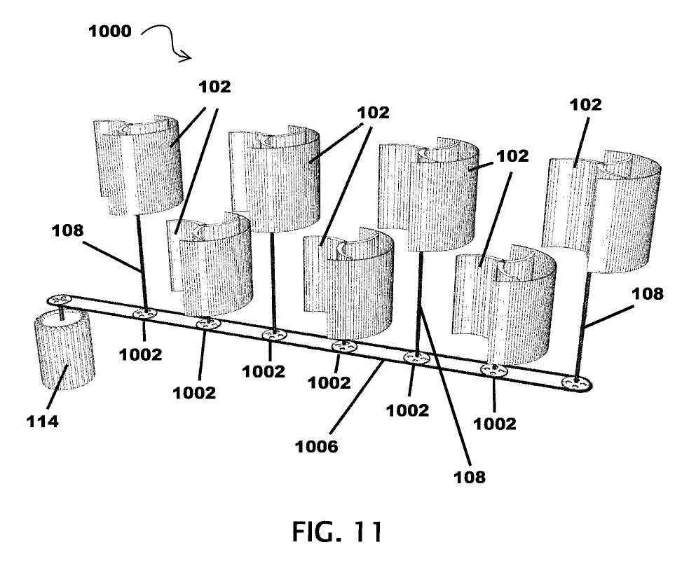

Referring now to FIG. 11, a multiple turbine energy collecting device 1000 comprises plurality of turbines with shrouds 102 mounted vertically on shafts 108. In the embodiment shown, turbines 102 engage a chain 1006 with a plurality of chain gears 1002. A spring loaded tensioner (not shown) is used to adjust the tension and to take an individual turbine 102 offline.

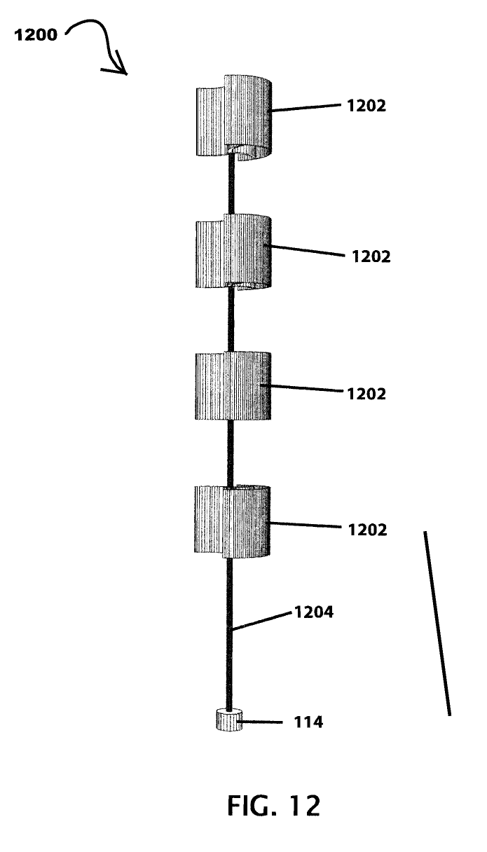

Reference is now made to FIG. 12; a multiple turbine energy collecting device 1200 comprises a plurality of turbines 1202 mounted vertically on a shaft 1204. In the embodiment shown, turbines directly turn shaft 1204. Of course a gearing mechanism (not shown) could be used to selectively engage drive shaft 1204 as is known in the art.

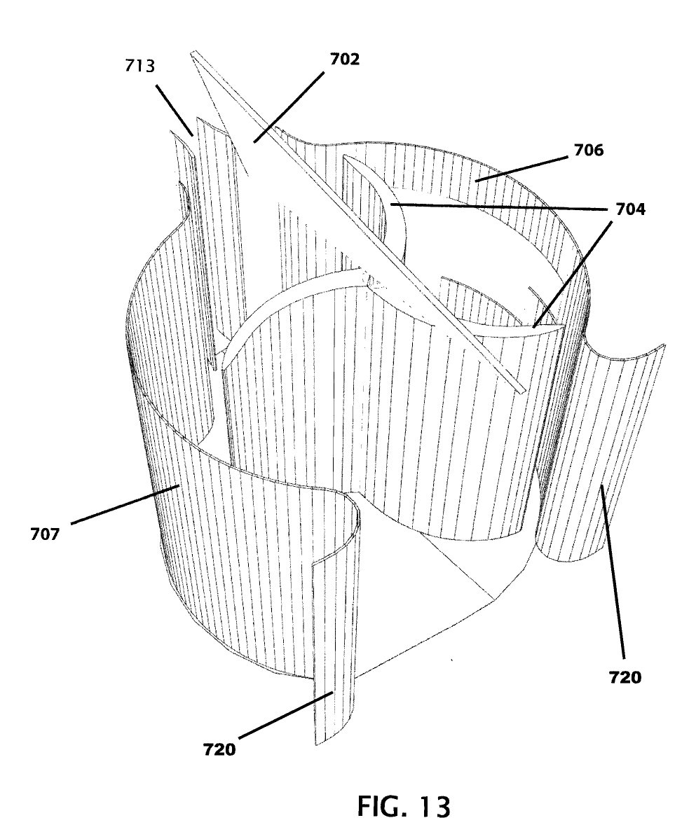

Referring to FIG. 13, a drag side shroud portion 706 works in conjunction with a lift side shroud portion 706 to further enhance the wind flow around turbine 704 through venturi 713. Shroud portions 706 and 707 have an intake portion 720 to further direct the airflow through shroud portions 706 and 707 exiting through venturi 713.

Shroud 706 can be mounted on any of the embodiments shown to increase efficiency. The size of shroud 706 can be varied and it is possible to use a greater number of smaller shrouds or fewer larger shrouds as long as portion of the airflow is directed through the venturi shaped opening 713.

Although the instant invention has been described in relation to particular embodiments thereof, many other variations and modifications and other uses will become apparent to those skilled in the art.

What is claimed is:

1. A multiple turbine energy producing device comprising:
a plurality of turbines;
a plurality of vertical shafts;
each one of said plurality of turbines being attached to said plurality of vertical shafts; and
a coupling means for combining the torque from each turbine to provide a combined rotary motion.

2. A multiple turbine energy producing device according to claim 1 further comprising a generator coupled to said coupling means to provide electrical power.

3. A multiple turbine energy producing device according to claim 1 further comprising an aerodynamic shroud covering at least a portion of said plurality of turbines to direct wind flow around said turbine.

4. A multiple turbine energy producing device according to claim 3 further comprising a wind vane connected to said aerodynamic shroud to direct said aerodynamic shroud to point into the wind.

5. A multiple turbine energy producing device according to claim 4 wherein said aerodynamic shroud is optimized to produce a laminar airflow around said plurality of turbines.

6. A multiple turbine energy producing device according to claim 1 wherein said coupling means is a belt assembly.

7. A multiple turbine energy producing device according to claim 6 further comprising a plurality of belt tensioners to adjust the tension of said belt assembly.

8. A multiple turbine energy producing device according to claim 1 wherein at least one of said plurality of turbines is at a different level than at least one other turbine.

9. A multiple turbine energy producing device according to claim 1 wherein said coupling means further comprises a plurality of gears to couple said plurality of turbines together.

10. A multiple turbine energy producing device according to claim 4 further comprising a venturi formed in a portion of said aerodynamic shroud.

11. A multiple turbine energy producing device according to claim 4 further comprising an inlet opening formed in said aerodynamic shroud.

12. A multiple turbine energy producing device according to claim 1 wherein each of said turbine has at least three lifting producing surfaces.

13. A multiple turbine energy producing device according to claim 1 wherein said coupling means is a chain assembly.

14. A multiple turbine energy producing device according to claim 1 wherein said coupling means is a drive shaft assembly.

15. A multiple turbine energy producing device comprising:
a plurality of turbines connected to a vertical shaft;
an aerodynamic shroud surrounding at least a portion of said plurality of turbines; and
an electrical generator coupled to said vertical shaft.
